(19) United States
(12) Patent Application Publication
(10) Pub. No.: US 2025/0214056 A1
(43) Pub. Date: Jul. 3, 2025

(54) THERMOCHEMICAL REACTOR SYSTEM AND SOLAR INSTALLATION WITH A THERMOCHEMICAL REACTOR SYSTEM

(71) Applicant: DEUTSCHES ZENTRUM FÜR LUFT- UND RAUMFAHRT E.V., Bonn (DE)

(72) Inventors: Fabio PIERNO, Köln (DE); Stefan BRENDELBERGER, Köln (DE)

(73) Assignee: DEUTSCHES ZENTRUM FÜR LUFT- UND RAUMFAHRT E.V., Bonn (DE)

(21) Appl. No.: 18/835,213

(22) PCT Filed: Feb. 2, 2023
(86) PCT No.: PCT/EP2023/052518

§ 371 Date: Aug. 1, 2024

(30) Foreign Application Priority Data
Feb. 2, 2022 (DE) 10 2022 102 460.1

(51) Int. Cl. B01J 19/18; B01J 19/00; C01B 3/06

(52) U.S. Cl. CPC B01J 19/18; B01J 19/0013; C01B 3/063; B01J 2219/00144

(57) ABSTRACT

A reactor system with a heating chamber, with at least one reactor with a reactor chamber, which has a first opening, and with a first isolating device, by way of which the first opening can be opened and can be closed in a gas-tight manner, wherein a conducting device for supplying and/or removing fluid is connected to the reactor chamber, wherein the at least one reactor has at least one reaction device with at least one block of solid medium, and with at least one transporting device, by way of which the at least one reaction device can be transported out of the reactor chamber through the first opening into a first position, in which the at least one reaction device is at least partially arranged in the heating chamber, and out of the heating chamber into a second position.

The present invention relates to a thermochemical reactor system as well as to a solar installation with a thermochemical reactor system.

It is known to use a redox material for the production of hydrogen or synthesis gas, wherein the redox material is used in redox cycle processes for the splitting of water and CO₂. The redox material is heated for the chemical reaction. In first approaches, heating is performed using solar energy, the redox material absorbing concentrated solar radiation.

According to first concepts, a particulate solid medium is used for the solar production of hydrogen by means of such thermochemical cycle processes. In this process, the solid medium is thermally reduced at high temperatures through a chemical reaction, using solar energy, and is thus activated for the subsequent reaction. Water vapor is supplied thereto at a later time. The medium is oxidized by the oxygen in the water so that hydrogen is produced. In order to continue the cycle process, the oxidized medium has to be reduced again at high temperatures. In the known cycle processes, the particles fall freely through the focal point of the concentrated solar radiation or are moved through the same. Thereafter, the particles are moved into a reactor to carry out the oxidation. Such methods may have the advantage of a continuous process, however, there are problems with respect to the abrasion of the particles, the forming of dust by particle abrasion, and the particle transport.

So-called solid receivers exist, in which the medium is fixedly installed in the receiver and is alternately reduced and oxidized in a batch process. Such receivers cause disadvantages, since the process is not continuous.

Further, a basic problem of the known receivers is a missing or insufficient recuperation of the heat between the reduction step and the oxidation step.

A system is known from DE 10 2018 201 319 A1, in which blocks of redox material are transported through the receiver by means of a conveyor device. Transporting the blocks through the receiver is problematic because of the high temperatures.

Basically, it is a problem to reliably operate a reactor system with a solar radiation-absorbent solid medium as a reaction medium or a heat carrier medium.

Therefore, it is an object of the present invention to provide a reactor system having a solar radiation receiver, which can, in an advantageous manner, preferably be operated continuously with a solar radiation-absorbent solid medium as a reaction medium or a heat carrier medium and be used for solar-operated redox cycle processes in an advantageous manner. Further, it is an object of the present invention to provide a solar installation having such a reactor system.

The reactor system according to the invention is defined by the features of claim 1. The solar installation according to the invention is defined by the features of claim 22.

The reactor system according to the invention has a heating chamber and at least one reactor with a reactor chamber, which has a first opening, and with a first isolating device, via which the first opening can be opened and closed in a gas-tight manner. A conducting device for supplying and/or discharging fluid is connected to the reactor chamber. The at least one reactor has at least one reaction device with at least one solid-medium block. The reactor system according to the invention further comprises at least one transport device, via which the at least one reaction device can be transported out of the reactor chamber through the first opening into a first position, in which the at least one reaction device is at least partially arranged in the heating chamber, and out of the heating chamber into a second position, in which the at least one reaction device is at least partially arranged in the reactor chamber of the at least one reactor. The at least one reaction device can be heated in its first position in the heating chamber to activate the at least one solid-medium block. The reactor chamber also has a second opening which is arranged on the reactor on the side opposite the first opening, wherein the at least one transport device can be guided or is guided through the second opening in order to transport the at least one reaction device, wherein the second opening can be opened and closed in a gas-tight manner via a second isolating device. The second isolating device has a sealing plate and a sealing device is arranged between the sealing plate and a wall section surrounding the second opening on the side of the sealing plate facing away from the reactor chamber.

Preferably, it is provided that the at least one reactor is arranged on the heating chamber, the reactor chamber being connected to the heating chamber via the first opening and being separable from the heating chamber by means of the first isolating device. The at least one reactor can therefore be arranged directly on the heating chamber or connected to it via a connecting member, for example.

The heating of the at least one reaction device in the heating chamber can, for example, take place via an arc plasma or a heat transfer medium, for example a gas, introduced into the heating chamber, whereby the heat transfer medium can be heated outside the reactor system in a conventional manner, for example via a combustion or solar process.

It may also be provided that the heating chamber has at least one radiation opening, whereby concentrated solar radiation can be introduced into the heating chamber through the radiation opening. The reaction device can be designed as a solar absorber device so that the concentrated solar radiation is radiated onto the solid-medium block and absorbed by it to heat the solid-medium block. It is also possible for the reaction device to be heated at least partially indirectly via solar radiation, in which the heating chamber is heated by concentrated solar radiation and the reaction device is heated by thermal radiation in the heating chamber and solar radiation reflected in the heating chamber.

The reactor system according to the invention advantageously enables the reaction device to be transported from the reactor chamber into the heating chamber and back into the reactor chamber again. The first and second isolating devices make it possible to create an atmosphere in the reactor chamber that is different from the environment and, for example, from the heating chamber, for carrying out a reaction, for example, by sealing the reactor chamber in a gas-tight manner by means of the first and second isolating devices. In the heating chamber, the solid-medium block can be activated by heating so that it is prepared for the subsequent reaction in the reactor chamber.

The fact that the sealing device is arranged between the sealing plate and the wall section surrounding the second opening on the side of the sealing plate facing away from the reactor chamber creates an axial seal. This is advantageous in that when excess pressure is generated in the reactor chamber, the sealing plate is pressed away from the reactor chamber in the closed state, which increases the contact pressure of the sealing device and thus increases the sealing effect.

The sealing device can be arranged on the sealing plate and/or the wall section surrounding the second opening.

The heating chamber can, for example, be arranged at a solar tower as a solar radiation receiver, wherein the concentrated solar radiation is directed onto the solar radiation receiver by means of one or a plurality of heliostats, or as a receiver on a solar dish system.

The solid-medium block can have a cube shape, a cuboid shape, a circular cylindrical or cylindrical shape, a conical shape or a more complex shape. For example, the reaction device can also have a plurality of solid-medium blocks that have one of the above-mentioned shapes. The reaction device can also have a plurality of solid-medium blocks, which are assembled into a rod shape, for example.

A circular-cylindrical solid-medium block has the particular advantage that relatively uniform heating can be achieved when irradiated from several sides, for example by means of heat radiation.

The solid-medium block can, for example, consist of a redox material such as CeO₂, doped CeO₂, Cu₂O/CuO, Mn₃O₄/Mn₂O₃, CoO/Ce₃O₄, ferrites (AₓFe₃₋ₓO₄) or perovskites. With the solid-medium block made from a redox material, activation takes place in the heating chamber as a reduction.

The material of the solid-medium block is preferably porous. Thereby, portions of concentrated solar radiation or thermal radiation that are radiated onto the reaction device in the heating chamber, can penetrate into the inside of the solid-medium block, so that an improved absorption of the radiation or solar radiation and thus an improved heating of the solid-medium block can be achieved. When heated with a heat transfer medium, the porosity creates a larger surface area, which improves heat transfer.

The increased surface area of the solid-medium block also provides an increased reaction surface when used as a reaction medium, which improves the reactions.

The reaction device according to the invention preferably has a solid medium block made of a redox material, so that the reaction device can be used in a redox cycle process. The redox material can be heated in the heating chamber in an appropriate atmosphere, for example also at lowered total pressure, by means of concentrated solar radiation, whereby the redox material is reduced. The reaction device is then transported into the reactor chamber, which can be isolated from the heating chamber by means of the isolating device. In the reactor chamber, water vapor, for example, is supplied to the reduced redox material via the line device, wherein the water vapor is split, whereby hydrogen is formed.

However, the reaction device according to the invention may also comprise a solid-medium block made of another material (e.g. a catalyst material) which is used for reactions other than redox reactions. For example, the solid-medium block can also consist of a material to whose surface molecules bind (adsorption), such as an alkali oxide or an alkaline earth oxide, for example CaO.

It is preferably provided that the at least one radiation opening is closed with a disc transparent to solar radiation.

A disc transparent to solar radiation is a disc having a hemispheric solar transmittance (AM1.5) of at least 85% for solar radiation. By providing a transparent disc in a radiation opening, the heating chamber can be closed, so that a desired atmosphere can be created in the receiver chamber.

For example, a gas extraction system, such as at least one vacuum pump, can be provided on the heating chamber so that a vacuum can be generated in the heating chamber. It is also possible to use flushing gas to remove oxygen. Appropriate lines can be connected to the heating chamber for the flushing gas. For example, in order to reduce the sold medium in the form of a redox material in the heating chamber by means of the concentrated solar radiation, the released oxygen may advantageously be drawn at least partially from the heating chamber by the gas extraction system. Thus, a low oxygen partial pressure prevails in the heating chamber, so that the reduction reaction is promoted and a repeated oxidation of the solid medium is prevented. To remove oxygen from the heating chamber, it can also be provided that an oxygen-absorbing material is arranged in the heating chamber or a chamber connected thereto. The oxygen-absorbing material can also be used in combination with a flushing gas, for example.

It is preferable that the at least one reactor is arranged below the heating chamber and that the transport device is designed as a vertical transport device. Such an arrangement makes it particularly easy to transport the reaction devices from the heating chamber into the reactor chamber and back, as they only have to be transported in one direction, namely vertically. Since the reaction devices have very high temperatures after irradiation with concentrated solar radiation, handling the reaction devices is relatively complex in terms of design due to the thermal loads on the environment. Due to the arrangement of the heating chamber and the reactor chamber according to the invention, a transport in only one direction is necessary, so that the transport device can be correspondingly simple in design. In this manner, the structural effort is kept comparatively low even at high thermal loads. Moreover, by arranging the at least one reactor directly at the heating chamber, the transport distances are very short.

It is preferably provided that the heating chamber has walls absorbing solar radiation, wherein solar radiation irradiated into the heating chamber through the at least one radiation opening can be absorbed to heat the walls. In other words: The heating chamber forms a cavity in which irradiated solar radiation is absorbed. Thus, the entire heating chamber is heated and a reaction device placed into the heating chamber can be heated by the thermal radiation emanating from the walls. Of course, it is also possible that the walls of the heating chamber partially reflect the solar radiation and the solar radiation is completely absorbed only after repeated reflection at the walls. The reflected solar radiation can, for example, also impinge on one of the reaction devices and be absorbed thereby, which also contributes to the heating of the reaction device.

The heating chamber may be adjoined by a receiving chamber separated from the heating chamber by a partition wall. In this case, the at least one transport device and the at least one reactor can be arranged in the receiving chamber. The first openings are provided in the partition wall, for example. In other words: The reactor system according to the invention can, for example, comprise a container divided in two parts, which forms the heating chamber and the receiving chamber. The heating chamber and the receiving chamber are separated from each other by the partition wall. The at least one first opening is provided in the partition wall. The at least one reactor is arranged on the side of the partition wall facing the receiving chamber and is fastened on the partition wall. The receiving chamber forms an advantageous space for arranging the at least one reactor and the at least one transport device. Of course, further parts of the reactor system according to the invention, such as lines, can be arranged in the receiving chamber. The partition wall separates the heating chamber and the receiving chamber. In addition, a thermal separation from the heating chamber can also be provided so that excessive heating of the receiving chamber is prevented.

Preferably, it is provided that the reactor system according to the invention comprises a plurality of reactors with at least one reactor chamber, each reactor chamber having a respective first opening via which the reactor chamber is connected, for example, to the heating chamber, wherein the first openings can each be opened and closed in a gas-tight manner via a first isolating device and wherein each reactor has a respective reaction device. In an embodiment with a heating chamber and a receiving chamber, all reactors can be arranged in the receiving chamber and the first openings can be formed in the partition wall.

By providing several reactors, several reaction devices can be used. This makes it possible to operate the reactor system according to the invention continuously, for example, by arranging only part of the reaction devices in the heating chamber and the other part for carrying out an oxidation reaction, for example, in the corresponding reactor chambers.

It may be provided that a transport device is arranged at each reactor. Of course, it is also possible for several reactors to share one transportation device.

The first isolating device can comprise a sliding plate that closes the first opening in a gas-tight manner. If several reactors are provided, each first isolating device can comprise a corresponding sliding plate. The first opening can be closed in a structurally simple way using a sliding plate. In addition, a sliding plate can be used to achieve a gas-tight seal of the closed first opening in an advantageous manner. For example, shortly before reaching its closed position, the sliding plate can be lifted by means of a bevel, for example by means of a wedge, to achieve a sealing effect, and can be pressed against a guide plate. It is preferable for the seal to be made on the side of the sliding plate facing the heating chamber, for example by means of a seal arranged on this side of the sliding plate. This is advantageous in that, by generating an overpressure in the reactor chamber, the sliding plate is pressed towards the heating chamber when closed, which increases the contact pressure of the seal.

In the second isolating device, it can be provided that the sealing plate is designed as a sliding plate that closes the second opening in a gas-tight manner. The first and second isolating devices can therefore have substantially the same design.

As an alternative to a sliding plate of the second separating device, it is also possible for the reaction device to have a base device on which the sealing plate is arranged. If a plurality of reactors is provided, each reaction device can have a corresponding base device. The second isolating device can thus also be designed in a form in which the base device of the reaction device forms at least part of the second isolating device. Here, the base device can support the at least one sols-medium block. Further, the transport device can engage the base device for transportation of the reaction device. The at least one solid-medium block can be fastened on the base device. This can be achieved through a connection device, e.g. by threading or by means of a rod. Moreover, the base device can be made of the same material as the at least one solid-medium block and be connected to the at least one solid-medium block by material bonding.

In this embodiment, in the second position, in which the reaction device is arranged in the reactor chamber, the sealing plate is in contact with the region surrounding the second opening so as to effect sealing. This embodiment also has the advantage that overpressure generated in the reactor chamber presses the sealing plate and thus the entire reaction device against this region.

In the embodiment in which the reaction device comprises a base device with a sealing plate, the transport device can be fixedly connected to the base device. A contact pressure of the sealing plate, which is necessary for achieving a sealing effect, can be generated through the transport device.

Basically, it is also possible that the transport device is designed to be releasable from the base device.

The first isolating device can comprise a vacuum seal and/or the sealing device of the second isolating device can comprise a vacuum seal. A sealing effect can be achieved in a particularly advantageous manner by means of a vacuum seal. It may further be provided that the first and/or second isolating device each comprise a further seal that reduces convective thermal transport to the vacuum seal. In this manner, the vacuum seal can be protected from excessive heating.

In an embodiment of the invention, it is provided that at least one holder for the reaction device is arranged in the reactor chamber. Thus, the transport device can place the reaction device on the holder so that the reaction device is arranged at a defined position in the reactor chamber. For transportation from the reactor chamber to the heating chamber, the transport device can remove the reaction device from the holder.

Preferably, the transport device is arranged outside the reactor chamber, wherein the transport device engages the reaction device when the second isolating device for transporting the reaction device into the heating chamber is open, releases it from the holder and moves it into the heating chamber. Transportation back into the reactor chamber takes place in a correspondingly reverse manner.

In a preferred embodiment of the reactor system according to the invention, the heating chamber has several radiation openings which are arranged on different sides of the heating chamber. In this way, concentrated solar radiation can be introduced into the heating chamber from different sides. The plurality of radiation openings can each be closed with a disc that is transparent to the solar radiation.

The at least one radiation aperture can comprise a secondary concentrator. Using the secondary concentrator, it can be achieved in an advantageous manner that a very large proportion of the solar radiation radiated onto the radiation opening reaches the heating chamber.

The heating chamber can have a circular cylindrical shape with a dome-shaped ceiling. The bottom of the heating chamber can also have a dome-shaped form. Such a type of heating chamber has proven to be particularly advantageous. In particular, if a vacuum is generated in the heating chamber by means of a vacuum pump to discharge oxygen, the circular cylindrical shape with a dome-shaped top and, possibly, a dome-shaped bottom can achieve a particularly high stability of the heating chamber.

It may also be provided that the receiving chamber has a circular cylindrical shape adapted to the heating chamber.

The invention further relates to a solar installation with a plurality of solar radiation concentrating reflectors and a reactor system according to the invention.

Here, it may be provided that the concentrating reflectors are designed as heliostats. If the heating chamber has a plurality of radiation openings, the heliostats can be arranged in subfields whose position is adapted to the individual positions of the radiation openings. This allows solar radiation to be concentrated on the reactor system from several sides in an advantageous manner, and allows solar radiation to be directed into the heating chamber in particularly effective manner in this way.

In the following, the present invention is explained in more detail with reference to the following Figures. In the Figures:

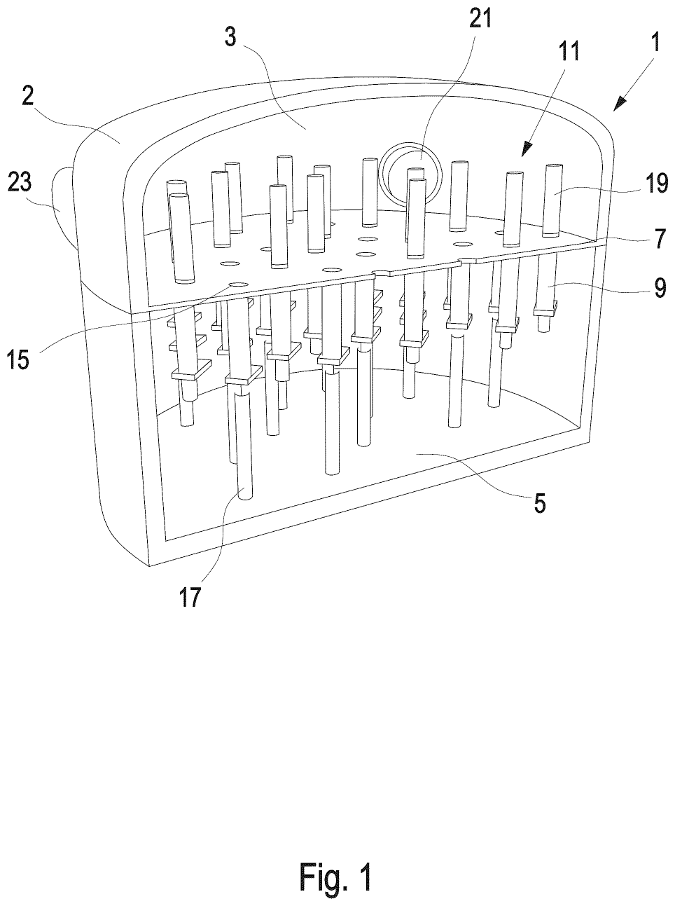

FIG. 1 is a schematic overall view of a reactor system according to the invention,

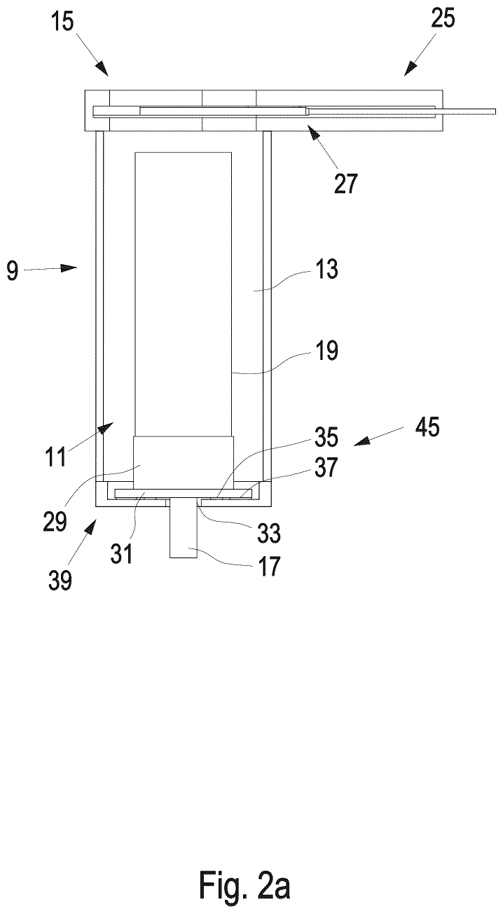

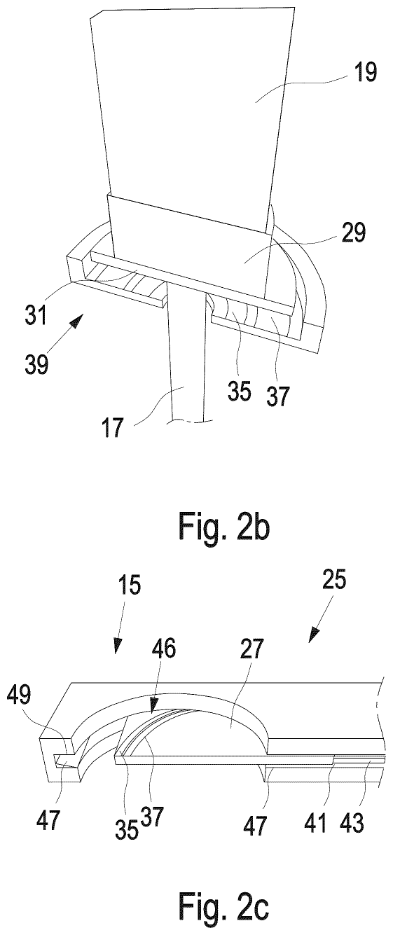

FIG. 2a is a schematic sectional view of a reactor of the reactor system according to the invention in FIG. 1,

FIG. 2b is a schematic detail of the reactor,

FIG. 2c is a schematic detail of the first isolating device of the reactor, and

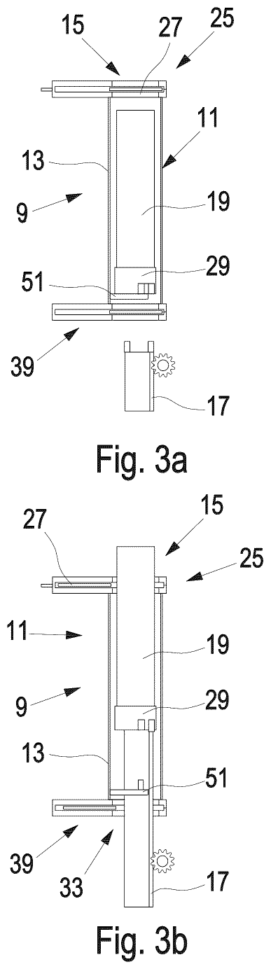

FIGS. 3a and 3b are schematic sectional views of a second variant of a reactor of a reactor system according to the invention.

FIG. 1 is a schematic overall view of a reactor system 1 according to the invention.

The reactor system 1 comprises a container 2 in which a heating chamber 3 is formed. Below the heating chamber 3, a receiving chamber 5 is arranged which is separated from the heating chamber 3 by a partition wall 7.

The container 2 is circular cylindrical in shape and has a dome-shaped ceiling that delimits the heating chamber 3.

Below the heating chamber 3, a plurality of reactors 9 is arranged in the receiving chamber 5, each comprising a reaction device 11.

As seen best in FIG. 2 which shows a schematic sectional view of a reactor 9, each reactor 9 comprises a reactor chamber 13. The reactor chambers 13 are each connected to the heating chamber 3 via a first opening 15 formed in the partition wall 7.

The reaction devices 11 can be transported through the first opening 15 from a first position, in which they are at least partially arranged in the heating chamber 3, to a second position, in which the reaction devices 11 are each at least partially arranged in one of the reactors 9. To transport the reaction devices 11, a transport device 17 is arranged on each reactor 9, which are also arranged in the receiving chamber 5.

In FIG. 1, some of the reaction devices 11 are shown in their first position. FIG. 2 shows the reaction device 11 in its second position.

The reaction devices 11 located in the heating chamber 3 can be heated in the heating chamber 3 so that a solid-medium block 19, which forms part of a respective reaction device 11, can be activated by reduction.

The heating chamber 3 can be heated for this purpose by means of solar radiation. To this end, the heating chamber 3 has several radiation openings 21 through which solar radiation can enter the interior of the heating chamber 3. Secondary concentrators 23 are arranged at the radiation openings 21, which improve the radiation input into the heating chamber 3.

The heating chamber 3 acts as a cavity so that solar radiation radiated into the heating chamber 3 is absorbed in the same. The solid-medium blocks 19 of the reaction devices 11 are heated and reduced by the heat present in the heating chamber 3 and in particular by thermal radiation from the walls of the heating chamber 3.

A vacuum can be generated in the heating chamber 3 by means of vacuum pumps not shown, so that the oxygen partial pressure in the heating chamber 3 is lowered and the solid-medium blocks 19 can be reduced in an advantageous manner.

After the reduction, the reaction devices 11 can be transported to the second position in which they are arranged in the reactors 9 in order to carry out a reaction, such as an oxidation. The transport devices 17, which are designed as vertical transport devices, for example, are lowered for transportation so that the reaction devices 11 are moved into the respective reactors 9.

As can be seen from FIG. 2a, the reactors 9 have a first isolating device 25 which can close the first opening 15. For this purpose, the isolating device 25 comprises a sliding plate 27 which closes the first opening 15 in a gas-tight manner.

The reaction device 11 comprises a base device 29 with a sealing plate 31. The solid-medium block 19 is arranged on the base device 29. The transport device 17 engages the bottom of the base device 29. On the side of the reactor 9 averted from the first opening 15, the reactor 9 has a second opening 33 through which the transport device 17 passes.

Using the sealing plate 31, the second opening 33 can be closed in a gas-tight manner. For this purpose, the sealing plate 31 sealingly abuts against a wall section of the reactor 9 which surrounds the second opening 33. Sealing is effected using a sealing device 45 formed by a vacuum seal 35 and a further seal 37 that surrounds the vacuum seal 35. The further seal 37 serves for thermal protection of the vacuum seal 35. Together with the vacuum seal 35 and the further seal 37, the sealing plate 31 forms a second isolating device 39 of the reactor 9 schematically shown in detail in FIG. 2b.

Sealing by means of the sealing plate 31 has the particular advantage that when overpressure is generated in the reactor chamber 13, a pressure acting on the sealing plate 31 and thus a downward force can be generated, so that the sealing plate 31 can additionally be pressed against the vacuum seal 35 and the further seal 37. A particularly advantageous sealing effect is caused thereby.

To carry out the reaction in the reactor 9, the first isolating device 25 and the second isolating device 39 are closed. A reaction gas can be introduced into the reaction chamber 13 via a line device not shown, and the reaction has can be oxidized, for example.

FIG. 2c shows a schematic detail of the first isolating device 25.

The sliding plate 27 is guided in a guide 41 and is displaced by means of a drive 43. On the side averted from the reactor chamber 13, another sealing device 46 is arranged on the sealing plate 27, which, similar to the seal of the second isolating device 39, can be formed by a vacuum seal 35 and a further seal 37.

The sliding plate 27 is displaced for closing. Wedges 47 are arranged in the guide 41, which press the sliding plate 27 in the direction of a sealing surface 49 shortly before it reaches its closed position, so that the further sealing device 46 is pressed against the sealing surface 49.

As with the second isolating device 39, the first isolating device 25 also achieves that an overpressure generated in the reaction chamber 13 increases the sealing effect by an additional force on the sliding plate 27.

The reactor 9 can be advantageously isolated from the heating chamber 3 by means of the first isolating device 25.

FIGS. 3a and 3b schematically show a second embodiment of a reactor 9 of a reactor system 1.

The reactor 9 shown in FIGS. 3a and 3b differs from the reactor 9 shown in FIGS. 2a to 2c substantially in the design of the reaction device 11 and the second isolation device 39.

In the second isolating device 39 of this embodiment, the sealing plate 31 is designed as a sliding plate, which is substantially identical to the sliding plate 27 of the first isolating device 25. It may be provided that the sliding plate of the second isolating device 39 is arranged substantially mirror-inverted to the sliding plate 27 of the first isolating device 25, so that the seals are arranged on the sliding plate of the second isolating device 39 on the side facing away from the reactor chamber 13.

A holder 51 is arranged in the reactor chamber 13, on which the reaction device 11 is placed and held in its second position. For this purpose, the base device 29 is adapted to the holder 51 so that the reaction device 11 is securely placed on the holder 51.

As can be seen from FIG. 3b, the second opening 33 can be opened by means of the second isolating device 39, so that the transport device 17 can enter the reactor chamber 13 in order to release the reaction device 11 from the holder 51 and push it through the first opening 15, which is cleared by the first isolating device 25, so that the solid-medium block 19 enters the heating chamber 3.

The reactor system 1 according to the invention can be part of a solar system and be arranged on a solar tower. Heliostats can be used to reflect the solar radiation and direct it onto the radiation openings 21.

The radiation openings 21 can be closed by discs that are transparent to the solar radiation.

Preferably, the solid-medium blocks 19 consist of so-called redox material, so that a redox reaction can be advantageously carried out by means of the reactor system according to the invention.

The reaction device 11 can have an elongated shape with a circular cylindrical solid-medium block 19. Such a shape has the particular advantage that relatively uniform heating can be achieved.

The transport device 17 can have a guide device arranged in the reactor 9. The same can be shielded from the reaction chamber 13 by means of insulation, which is also used as a radiation shield. The insulation can form a gap or a plurality of gaps through which a gripper of the transport device 17 is passed, which engages the reaction device 11, for example the base device 29, in order to transport the reaction device 11. The guide device can, for example, be formed by two opposing rails, each of which is arranged on a side wall of the reactor 9 and each of which is shielded from the reaction chamber 13 by insulation.

As can be seen from FIG. 1, it can be provided that only some of the solid-medium blocks 19 are in their first position at a time and thus in the heating chamber 3. The other solid-medium blocks 19 are in their second position in the respective reactors 9. In this way, the reactor system 1 according to the invention can be operated continuously.

### LIST OF REFERENCE NUMERALS

1 reactor system
2 container
3 heating chamber
5 receiving chamber
7 partition wall
9 reactor
11 reaction device
13 reactor chamber
15 first opening
17 transport device
19 solid medium block
21 radiation opening
23 secondary concentrator
25 first isolator device
27 sliding plate
29 base device
31 sealing plate
33 second opening
35 vacuum seal
37 seal
39 second isolating device
41 guide
43 drive
45 sealing device
47 wedges
49 sealing surface
51 holder

1-22. (canceled)

23. A reactor system,
with a heating chamber,
with at least one reactor with a reactor chamber, which has a first opening, and with a first isolating device, by way of which the first opening can be opened and can be closed in a gas-tight manner,
wherein a line device for supplying and/or removing fluid is connected to the reactor chamber,
wherein the at least one reactor has at least one reaction device with at least one block of solid medium,
and with at least one transporting device, by way of which the at least one reaction device can be transported out of the reactor chamber through the first opening into a first position, in which the at least one reaction device is at least partially arranged in the heating chamber, and out of the heating chamber into a second position, in which the at least one reaction device is at least partially arranged in the reaction chamber of the at least one reactor, wherein the at least one reaction device can be heated in the heating chamber for activating the at least one block of solid medium,
wherein the reactor chamber has a second opening, which is arranged on the side of the reactor that is opposite from the first opening, wherein the at least one transporting device can be led or has been led through the second opening in order to transport the at least one reaction device, and a second isolating device, by way of which the second opening can be opened and can be closed in a gas-tight manner,
wherein the second isolating device has a sealing plate, and wherein, between the sealing plate and a wall section surrounding the second opening, a sealing device is arranged on the side of the sealing plate that is facing away from the reactor chamber.

24. The reactor system according to claim 23, wherein the at least one reactor is arranged on the heating chamber, the reactor chamber being connected to the heating chamber via the first opening and being isolatable from the heating chamber by means of the first isolating device.

25. The reactor system according to claim 23, wherein the heating chamber comprises at least one radiation opening, wherein concentrated solar radiation can be introduced into the heating chamber through the radiation opening.

26. The reactor system according to claim 25, wherein the at least one radiation opening is closed with a disc transparent to solar radiation.

27. The reactor system according to claim 25, wherein the heating chamber has walls absorbing solar radiation, wherein solar radiation irradiated into the heating chamber through the at least one radiation opening can be absorbed to heat the walls.

28. The reactor system according to claim 23, wherein the at least one reactor is arranged below the heating chamber, and that the transport device is designed as a vertical transport device.

29. The reactor system according to claim 24, wherein the heating chamber is adjoined by a receiving chamber separated from the heating chamber via a partition wall, wherein the at least one transport device and the at least one reactor are arranged in the receiving chamber, with the at least one first opening being arranged in the partition wall.

30. The reactor system according to claim 23, further comprising: a plurality of structures, each with a reactor chamber, each reactor chamber having a first opening, said first openings each being adapted to be opened and closed in a gas-tight manner by means of a first isolating device, and each reactor having a reaction device.

31. The reactor system according to claim 30, further comprising a respective transport device arranged on each reactor.

32. The reactor system according to claim 23, wherein the first isolating device has a sliding plate which closes the first opening in a gas-tight manner, or the first isolating devices each have a sliding plate which closes the respective first openings in a gas-tight manner.

33. The reactor system according to claim 23, wherein the sealing plate of the second isolating device is designed as a sliding plate, or sealing plates of the second isolating devices are each designed as a sliding plate.

34. The reactor system according to claim 23, wherein the reaction device has a base device on which the sealing plate is arranged, or the reaction devices each have a base device on which a sealing plate is arranged in each case.

35. The reactor system according to claim 23, wherein the first isolating device has a vacuum seal and/or in that the sealing device of the second isolating device has a vacuum seal.

36. The reactor system according to claim 13, wherein the first and/or second isolating device each has a further seal, which reduces convective thermal transport to the vacuum seal.

37. The reactor system according to claim 25, wherein the heating chamber has a plurality of radiation openings which are arranged on different sides of the heating chamber.

38. The reactor system according to claim 3, wherein the at least one radiation opening has a secondary concentrator or the radiation openings each have a secondary concentrator.

39. The reactor system according to claim 23, wherein the heating chamber has at least one vacuum pump.

40. The reactor system according to claim 23, wherein the heating chamber has a circular cylindrical shape with a dome-shaped ceiling.

41. The reactor system according to claim 40, wherein the underside of the heating chamber is dome-shaped.

42. The reactor system according to claim 40, wherein the receiving chamber has a circular cylindrical shape adapted to the heating chamber.

43. A solar installation with a plurality of solar radiation concentrating reflectors and a reactor system according to claim 23.

44. The solar installation according to claim 41, wherein the concentrating reflectors are designed as heliostats, the heliostats being arranged in subarrays whose position is adapted to the individual positions of the radiation openings.
